(19) United States
(12) Patent Application Publication
(10) Pub. No.: US 2010/0146174 A1
(43) Pub. Date: Jun. 10, 2010

(54) Method for Protecting Against External Interventions into a Master/Slave Bus System and Master/Slave Bus System

(75) Inventor: Dejan Djordjevic, Stuttgart (DE)

Correspondence Address: LERNER GREENBERG STEMER LLP, P O BOX 2480, HOLLYWOOD, FL, 33022-2480, US

(73) Assignee: DR. ING. H.C. F. PORSCHE AKTIENGESELLSCHAFT, Weissach (DE)

(21) Appl. No.: 12/604,488

(22) Filed: Oct. 23, 2009

(30) Foreign Application Priority Data
Dec. 6, 2008 (DE) 102008060984.6

(51) Int. Cl. G06F 13/00

(52) U.S. Cl. 710/110

(57) ABSTRACT

The method serves for protecting against external interventions into a master/slave bus system. The master/slave bus system contains at least one slave and at least one authorized master for outputting an authentic command. The authentic command instructs the slave to carry out a function. Accordingly, the authenticity of the command which has been transmitted over the bus is checked. The execution of the function is enabled only in the event of a positive check result.

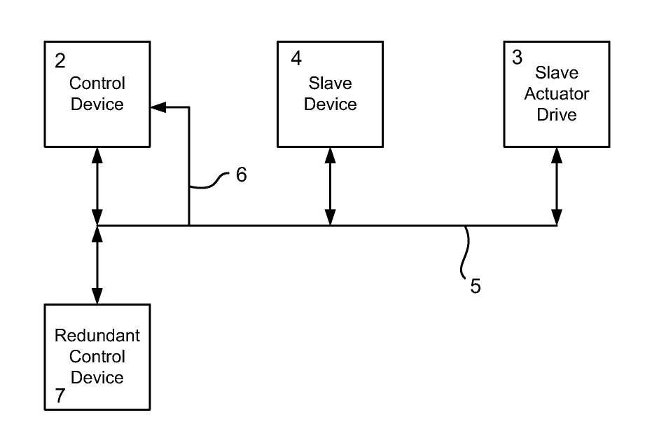

### CROSS-REFERENCE TO RELATED APPLICATION

This application claims the priority, under 35 U.S.C. § 119, of German application DE 10 2008 060 984.6, filed Dec. 6, 2008; the prior application is herewith incorporated by reference in its entirety.

### BACKGROUND OF THE INVENTION

### Field of the Invention

The invention relates to a method for protecting against external interventions into a master/slave bus system having at least one slave and at least one authorized master for outputting an authentic command which instructs the slave to carry out a function. The invention also relates to a master/slave bus system.

Opening and closing elements, such as side windows and sun roofs, which are moved by an actuator system are sufficiently known from motor vehicle engineering. In modern motor vehicles, the actuator system and the control device which drives the actuator system are interconnected by a bus system. The local interconnect network (LIN) protocol is being increasingly used as the protocol according to which the motor vehicle bus systems operate.

A LIN bus system is a master/slave bus system in which a master feeds onto the bus a command which instructs an actuator system to operate.

There is then the risk of a person who is not authorized to access the vehicle making an illegitimate attempt to feed a command onto the LIN bus in order to instruct the actuator system to trigger a movement of the opening and closing part in the direction of the open position so that a person can gain access to the passenger compartment of the vehicle.

### SUMMARY OF THE INVENTION

It is accordingly an object of the invention to provide a method for protecting against external interventions into a master/slave bus system and a master/slave bus system which overcome the above-mentioned disadvantages of the prior art methods and devices of this general type.

The method serves to protect against external interventions into a master/slave bus system. The master/slave bus system which is provided, in particular, for a motor vehicle contains at least one slave and at least one authorized master for outputting an authentic command. The authentic command instructs the slave to carry out a function. According to the invention, the authenticity of a command which has been transmitted over the bus is checked. The execution of the function is enabled only in the event of a positive check result.

In one embodiment variant of the method according to the invention, the master/slave bus system operates according to LIN (Local Interconnect Network) protocol.

According to one embodiment of the method according to the invention, by reading back into the authorized master a command, in particular every command, which has been transmitted over the bus, checking is carried out to determine whether or not the command was output by the authorized master.

In order to prevent incorrect control operations owing to a failure of the authorized master, for example due to violent destruction on the part of the person for whom access is not authorized, in one embodiment of the method according to the invention a redundancy master, to which switching over occurs in the event of failure of the authorized master, is connected to the bus.

According to one embodiment of the method according to the invention, a slave actuator drive, which is driven by the authorized master moves an opening and closing part between an open position and a closed position. In this context, the opening and closing part clears an opening into the passenger compartment of the vehicle, while in the closed position the opening is closed by the opening and closing part.

Other features which are considered as characteristic for the invention are set forth in the appended claims.

Although the invention is illustrated and described herein as embodied in a method for protecting against external interventions into a master/slave bus system and a master/slave bus system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWING

The single FIGURE of the drawing is a block diagram illustrating an exemplary embodiment of a method according to the invention.

### DETAILED DESCRIPTION OF THE INVENTION

Referring now to the single FIGURE of the drawing, there is shown a block diagram of a bus system 1 of a motor vehicle. A rear vehicle body control device 2 which is operated in the master mode, a slave actuator drive 3 and a further slave device 4 which is assigned to the overhead console are connected to the bus system 1 which operates according to the LIN protocol.

The slave actuator drive 3 adjusts a sunroof in response to commands which are fed onto a LIN bus 5 by the rear vehicle body control device 2.

By reading back (arrow 6) into the rear vehicle body control device 2 every command which has been transmitted over the LIN bus 5, checking is carried out in the rear vehicle body control device 2 in order to determine whether or not the relevant command was output by the rear vehicle body control device 2.

The LIN bus system 1 is configured in such a way that in the event of failure of the rear vehicle body control device 2 switching over is performed to a redundant front vehicle body control device 7 which is connected to the LIN bus.

Although the invention has been described using the example of a sunroof closure system, a wide variety of applications or refinements in other devices are conceivable without departing from the invention here.

1. A method for protecting against external interventions into a master/slave bus system having at least one slave and at least one authorized master for outputting an authentic command for instructing the slave to carry out a function, which comprises the step of:
checking an authenticity of a command which has been transmitted over a bus; and
enabling an execution of the function in an event of a positive check result.

2. The method according to claim 1, which further comprises operating the master/slave bus system according to a local interconnect network protocol.

3. The method according to claim 1, which further comprises:
reading back into the authorized master the command which has been transmitted over the bus; and
checking whether or not the command was output by the authorized master.

4. The method according to claim 1, which further comprises:
connecting a redundancy master to the bus; and switching over to the redundancy master in an event of failure of the authorized master.

5. The method according to claim 1, wherein a slave actuator drive, which is driven by the authorized master, moves an opening and closing part between an open position, in which the opening and closing part clears an opening into a passenger compartment of a vehicle, and a closed position in which the opening is closed by the opening and closing part.

6. A master/slave bus system, comprising:
at least one slave;
at least one authorized master for outputting an authentic command for instructing said slave to carry out a function;
a bus connecting said slave to said authorized master; and
authenticity checking means configured to check an authenticity of the authentic command transmitted over said bus and to enable an execution of the function only in an event of a positive check result.

7. The master/slave bus system according to claim 6, wherein said master/slave bus system operates according to a local interconnect network protocol.

8. The master/slave bus system according to claim 6, wherein the master/slave bus system is configured to check, by reading back into said authorized master the authentic command which has been transmitted over said bus, whether or not the authentic command was output by said authorized master.

9. The master/slave bus system according to claim 6, further comprising a redundancy master connected to said bus, and switching over to said redundancy master in an event of a failure of said authorized master.
